(19) United States
(12) Patent Application Publication
(10) Pub. No.: US 2017/0019477 A1
(43) Pub. Date: Jan. 19, 2017

(54) INFORMATION STORAGE APPARATUS, INFORMATION STORAGE METHOD, AND INFORMATION PROCESSING SYSTEM

(71) Applicant: Kazuhiro YAMADA, Kanagawa (JP)

(72) Inventor: Kazuhiro YAMADA, Kanagawa (JP)

(73) Assignee: Ricoh Company, Ltd., Tokyo (JP)

(21) Appl. No.: 15/201,712

(22) Filed: Jul. 5, 2016

(30) Foreign Application Priority Data
Jul. 13, 2015 (JP) 2015-139400

(51) Int. Cl. H04L 29/08; H04L 12/26

(52) U.S. Cl. CPC H04L 67/1097; H04L 67/1002; H04L 43/08; H04L 43/04

(57) ABSTRACT

An information storage apparatus includes a storage unit having a storage area that is accessible via a network. A process to be executed using electronic data stored in the storage area is set up in association with the storage area. The information storage apparatus further includes a processor that executes a program stored in a memory to implement processes of detecting the electronic data being stored in the storage area, and executing the process set up in association with the storage area storing the electronic data using the electronic data stored therein. The processor further determines a waiting time from detecting the electronic data being saved in the storage area to requesting the execution of the process set up in association with the storage area storing the electronic data, based on the type of operation performed for storing the electronic data in the storage area via the network.

### CROSS-REFERENCE TO RELATED APPLICATIONS

The present application claims priority under 35 U.S.C. §119 to Japanese Patent Application No. 2015-139400 filed on Jul. 13, 2015, the entire contents of which are incorporated herein by reference.

### BACKGROUND OF THE INVENTION

1. Field of the Invention

The present disclosure relates to an information storage apparatus, information storage method, and information processing system.

2. Description of the Related Art

In print systems using a personal computer, data may be input to a specific folder that is associated with a predetermined process (so-called “hot folder”). By inputting data in the hot folder, a preregistered print process may be executed using the input data.

For example, Japanese Patent No. 3717679 discloses a print system that detects print data being saved in a hot folder and registers the print data as a print output job to reduce the work load of an operator.

In print systems using a hot folder, even when a user mistakenly saves print data in the hot folder, the print data will still be immediately registered as a print output job.

In view of such a problem, measures may be implemented to have print data registered as a print output job only after a predetermined time elapses from the time the print data is saved in the hot folder so that the user may have the opportunity to delete print data that has been saved in the hot folder by mistake and thereby cancel the registration of the print output job.

However, in print systems configured to register a print output job only after a predetermined time elapses from the time print data is saved in the hot folder, accommodations cannot be made for cases where print data is preferably registered as a print output job immediately after the print data is saved in the hot folder.

### SUMMARY OF THE INVENTION

An aspect of the present invention is directed to providing an information storage apparatus that is capable of flexibly adjusting a waiting time for executing a process associated with a storage area.

According to one embodiment of the present invention, an information storage apparatus includes a storage unit including a storage area that is accessible via a network, the storage unit being configured to set up a process to be executed using electronic data stored in the storage area in association with the storage area. The information storage apparatus further includes a processor that executes a program stored in a memory to implement processes of detecting the electronic data being stored in the storage area, and executing the process set up in association with the storage area storing the electronic data using the electronic data stored in the storage area. The processor further determines a waiting time from detecting the electronic data being saved in the storage area to requesting the execution of the process set up in association with the storage area storing the electronic data, based on the type of operation performed for storing the electronic data in the storage area via the network.

### BRIEF DESCRIPTION OF THE DRAWINGS

FIG. 1 is a diagram illustrating an example configuration of an information processing system according to a first embodiment of the present invention;

FIG. 2 is a block diagram illustrating an example hardware configuration of a computer according to the first embodiment;

FIG. 3 is a block diagram illustrating an example hardware configuration of an image processing apparatus according to the first embodiment;

FIG. 4 is a block diagram illustrating an example functional configuration of an information storage apparatus according to the first embodiment;

FIG. 5 is a diagram illustrating an example folder configuration of a file server according to the first embodiment;

FIG. 6 is a sequence chart illustrating an example process procedure of the information processing system according to the first embodiment;

FIG. 7 is a diagram illustrating an example process of a user saving a file in a workflow folder by a drag and drop operation;

FIG. 8 is a sequence chart illustrating another example process procedure of the information processing system according to the first embodiment;

FIG. 9 is a diagram illustrating an example file display screen;

FIG. 10 is a diagram illustrating an example upload destination folder selection screen;

FIG. 11 is a flowchart illustrating an example process procedure of a standby process according to the first embodiment;

FIG. 12 is a flowchart illustrating another example process procedure of the standby process according to the first embodiment;

FIG. 13 is a flowchart illustrating another example process procedure of the standby process according to the first embodiment;

FIG. 14 is a table illustrating an example of a waiting time varying depending on the file type;

FIG. 15 is a table illustrating an example of the waiting time varying depending on the file size;

FIG. 16 is a table illustrating an example of the waiting time varying depending on the type of process set up in association with the workflow folder;

FIG. 17 is a sequence chart illustrating an example process procedure of the information processing system according to a second embodiment of the present invention;

FIG. 18 is a flowchart illustrating an example process procedure of a control file generation process; and

FIG. 19 is a flowchart illustrating an example process procedure of the standby process according to the second embodiment.

### DESCRIPTION OF THE EMBODIMENTS

In the following, embodiments of the present invention are described with reference to the accompanying drawings.

### First Embodiment

<System Configuration>

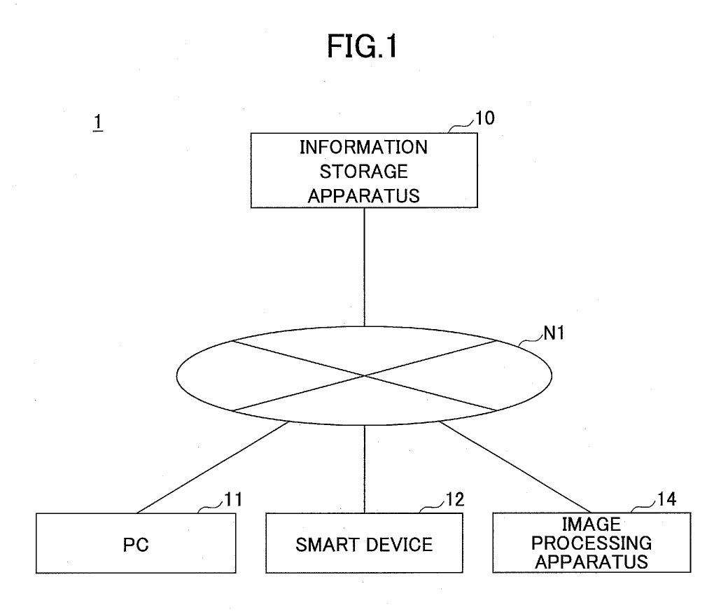

FIG. 1 is a diagram illustrating an example configuration of an information processing system 1 according to a first embodiment of the present invention. The information processing system 1 of FIG. 1 includes an information storage apparatus 10, a PC 11, a smart device 12, and an image processing apparatus 14 that are connected to a network N1. The network N1 may be the Internet or an intranet using a wired LAN (Local Area Network) or a wireless LAN, for example.

The PC 11 is an example of a terminal apparatus, which may be a desktop PC or a laptop PC, for example. The smart device 12 is another example of a terminal apparatus, which may be a smart phone or a tablet terminal, for example. The image processing apparatus 14 is an example of an electronic device, such as a multi-functional peripheral (MFP), a printer, a scanner, or a projector, for example.

The information storage apparatus 10 is configured to implement functions of a file server that is capable of acquiring a file from the PC 11, the smart device 12, and the image processing apparatus 14 via the network N1, and storing the acquired file. Further, the information storage apparatus 10 is configured to perform a preregistered process when a file is saved in a folder that is associated with a process. Note that in the following descriptions, such a folder that is associated with a process may be referred to as a “workflow folder”. Note, also, that such a folder is an example of a storage area (storage location) for storing electronic data including files, and may also be referred to as a “directory”.

The PC 11 may be used to store a file in the information storage apparatus 10 or browse a file stored in the information storage apparatus 10. For example, the PC 11 may use the SMB (Server Message Block) protocol to cause a file management application to store a file in the information storage apparatus 10 or browse a file stored in the information storage apparatus 10.

The smart device 12 may be used to store a file in the information storage apparatus 10 or browse a file stored in the information storage apparatus 10. For example, the smart device 12 may use the HTTP protocol to cause a dedicated application to store a file in the information storage apparatus 10 or browse a file stored in the information storage apparatus 10.

The image processing apparatus 14 is capable of generating a file to be stored in the information storage apparatus 10 and outputting (e.g., printing, displaying, or projecting) a file stored in the information storage apparatus 10. For example, the image processing apparatus 14 may include a scanner function for scanning a document, and the image processing apparatus 14 may generate image data of the document using the scanner function and store the generated image data in the information storage apparatus 10. Further, the image processing apparatus 14 may have a printer function for printing a file stored in the information storage apparatus 10, for example.

The image processing apparatus 14 uses the HTTP protocol to cause a dedicated application to store a file in the information storage apparatus 10 or acquire a file stored in the information storage apparatus 10.

Note that the configuration of the information processing system 1 of FIG. 1 is merely one example, and the information processing system 1 according to the present embodiment may include a plurality of the PC 11, the smart device 12, and the image processing device 14, for example. Further, the information storage apparatus 10 may be configured by a single computer or a plurality of computers. Also, embodiments of the present invention may be applied to a device other than the PC 11, the smart device 12, and the image processing apparatus 14 as long as the device is connected to the network N1 and is capable of handling a general-purpose image file format, for example.

<Hardware Configuration>

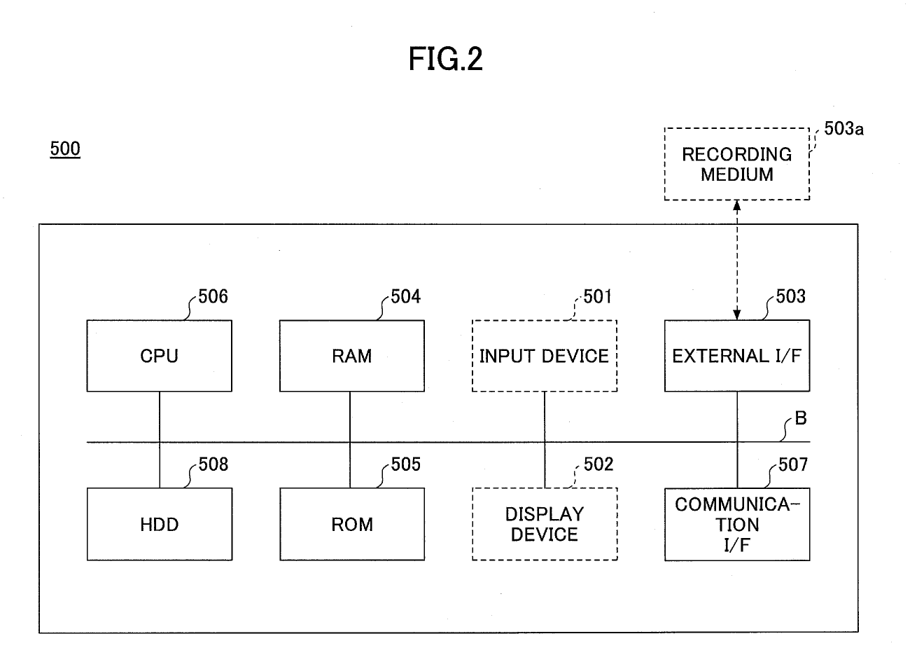

The information storage apparatus 10, the PC 11, and the smart device 12 may be implemented by a computer having a hardware configuration as illustrated in FIG. 2, for example. FIG. 2 is a block diagram illustrating an example hardware configuration of a computer 500 according to an embodiment of the present invention.

In FIG. 2, the computer 500 includes an input device 501, a display device 502, an external I/F (interface) 503, a RAM (Random Access Memory) 504, a ROM (Read Only Memory) 505, a CPU (Central Processing Unit) 506, a communication I/F 507, and a HDD (Hard Disk Drive) 508 that are connected to each other by a bus B. The computer 500 may also include a camera, a microphone, and/or a speaker, for example. Also, the input device 501 and the display device 502 may be configured to be connectable to the computer 500 when necessary, for example.

The input device 501 may include a keyboard, a mouse, and/or a touch panel, for example, and is used for inputting various signals to the computer 500. The display device 502 may include a display for displaying various processing results, for example. The communication I/F 507 is an interface for connecting the computer 500 to the network N. The computer 500 establishes data communication via the communication I/F 507.

The HDD 508 is a nonvolatile storage device that stores programs and data. The programs and data stored in the HDD 508 may include an OS (Operating System) as basic software for controlling the entire computer 500, and various application programs running on the OS, for example. Note that the HDD 508 manages the programs and data stored therein using a predetermined file system and/or a database (DB), for example.

The external I/F 503 is an interface with an external device. The external device may be a recording medium 503a, for example. The computer 500 may read/write (store) data from/in the recording medium 503a via the external I/F 503. Examples of the recording medium 503a include a flexible disk, a CD (Compact Disk), a DVD (Digital Versatile Disk), an SD memory card, and a USB (Universal Serial Bus) memory.

The ROM 505 is a nonvolatile semiconductor memory (storage device) that is capable of retaining data even when the power is turned off. The ROM 505 stores programs and data, such as BIOS (basic input/output system) that is executed when the computer 500 is started, OS settings, and network settings, for example. The RAM 504 is a volatile semiconductor memory (storage device) for temporarily storing programs and data.

The CPU 506 is a computing unit that can perform various types of processes for controlling the entire computer 500 and implementing its functions by loading programs and data stored in the HDD 508 or the ROM 505 into the RAM 504. For example, the computer 500 may use one or more of the above-described hardware elements to execute a program to implement various processes of the present embodiment as described below.

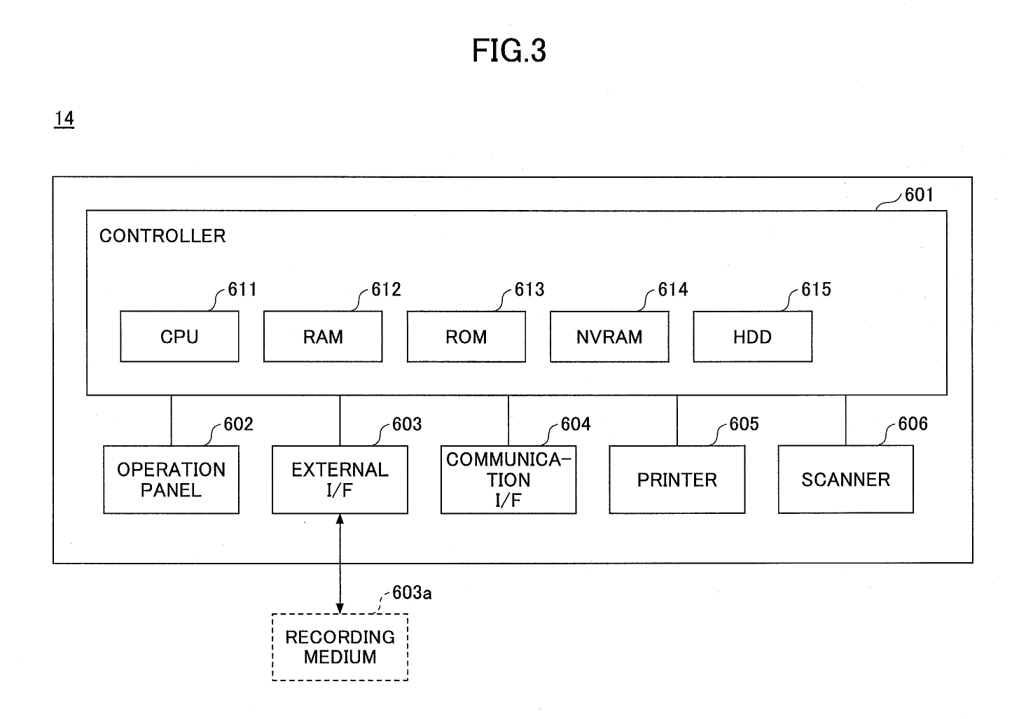

The image processing apparatus 14 of FIG. 1 may be an MFP having a hardware configuration as illustrated in FIG. 3, for example. FIG. 3 is a block diagram illustrating an example hardware configuration of the image processing apparatus 14 according to the present embodiment.

In FIG. 3, the image processing apparatus 14 includes a controller 601, an operation panel 602, an external I/F 603, a communication I/F 604, a printer 605, and a scanner 606.

The controller 601 includes a CPU 611, a RAM 612, a ROM 613, a NVRAM 614, and an HDD 615. The ROM 613 stores various programs and data. The RAM 612 temporarily stores programs and data. The NVRAM 614 stores setting information, for example. The HDD 615 also stores various programs and data.

The CPU 611 controls and implements functions of the image processing apparatus 14 by loading programs, data, and/or setting information from the ROM 613, the NVRAM 614, and/or the HDD 615 into the RAM 612 to execute various processes for controlling the entire image processing apparatus 14 and implementing its functions, for example.

The operation panel 602 includes an input device for receiving an input from a user, and a display device for displaying information. The external I/F 603 is an interface with an external device. The external device may be a recording medium 603a, for example. The image processing apparatus 14 can read/write (store) data from/in the recording medium 603a via the external I/F 603. The recording medium 603a may be an IC card, a flexible disk, a CD, a DVD, an SD memory card, or a USB memory, for example.

The communication I/F 604 is an interface for connecting the image processing apparatus 14 to the information storage apparatus 10 via the network N. In this way, the image processing apparatus 14 can establish data communication with the information storage apparatus 10 via the communication I/F 604. The printer 605 is a printing device for printing print data on paper, for example. The scanner 606 is a scanning device for generating image data (electronic data) by scanning a document, for example.

<Software Configuration>

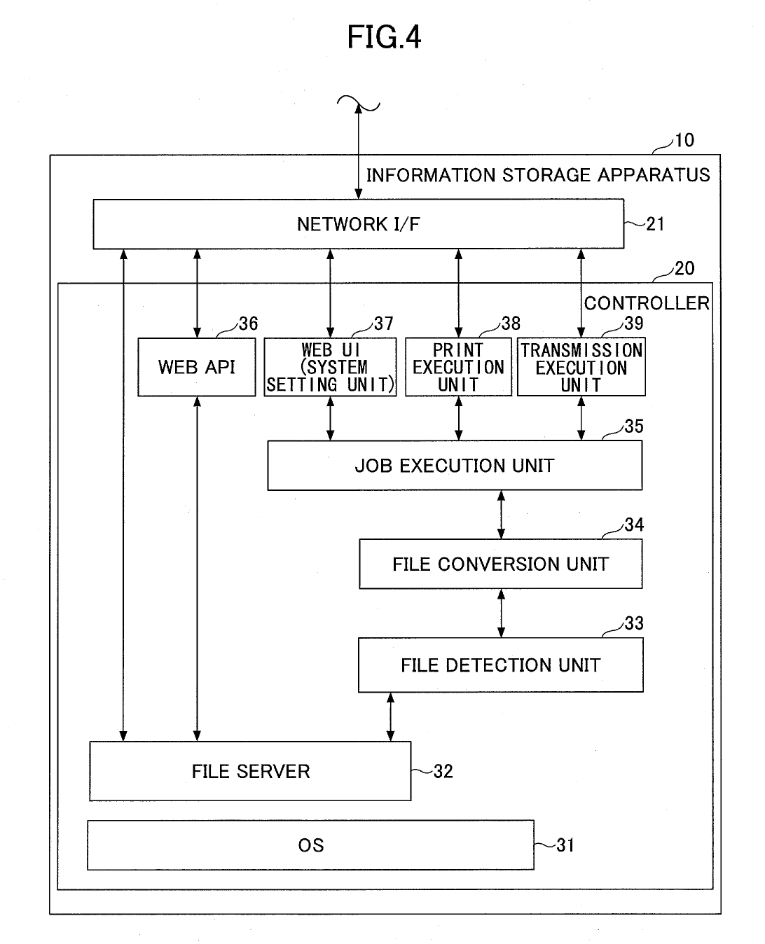

The information storage apparatus 10 according to the first embodiment may be implemented by the computer 500 having a functional configuration as illustrated in FIG. 4, for example. FIG. 4 is block diagram illustrating an example functional configuration of the information storage apparatus 10 according to the first embodiment. In FIG. 4, the information storage apparatus 10 includes a controller 20 and a network I/F 21.

The network I/F 21 is an interface for enabling the information storage apparatus 10 to communicate with the PC 11, the smart device 12, and the image processing apparatus 14 via the network N1. For example, an Ethernet (registered trademark) interface or a USB (Universal Serial Bus) interface may be used as the network I/F 21.

The controller 20 may be implemented by a combination of software and hardware, for example, and is configured to control the overall operations of the information storage apparatus 10. More specifically, the controller 20 of FIG. 4 is configured to control the information storage apparatus 10 using an OS 31, a file server 32, a file detection unit 33, a file conversion unit 34, a job execution unit 35, a web API (application programming interface) 36, a web UI (user interface) 37, a print execution unit 38, and a transmission execution unit 39.

The OS 31 is the operating system of the information storage apparatus 10 and controls the entire information storage apparatus 10. The file server 32 is a folder provided on the network N1 using the SMB protocol or the Web Distributed Authoring and Versioning (WebDAV) protocol, for example. The PC 11, the smart device 12, and the image processing apparatus 14 are able to access the folder provided by the file server 32 via the network. N1.

The file detection unit 33 is a module for detecting a file being saved in a folder of the file server 32. For example, the file detection unit 33 may detect that a file has been saved in the folder of the file server 32 by polling the file system or implementing a callback method for receiving a callback from the file system.

The file conversion unit 34 performs a process of converting data such as print data into a different file format in response to a request from the file detection unit 33. The job execution unit 35 executes an output process based on settings of a workflow folder set up by a user in advance via the web UI 37.

The web API (Application Programming Interface) 36 receives an HTTP request from an application (app) installed in the smart device 12 or the image processing device 14, for example. In a case where the received HTTP request is a file storage request, the web API 36 executes a process of storing a file in a folder of the file server 32. Note that such a file is an example of electronic data stored in the folder.

The web UI 37 is an example of a system setting unit that accepts and holds settings (e.g., workflow folder settings) for the information storage apparatus 10 input by a user. The user may be able to register or change settings of the information storage apparatus 10 via the web UI 37 using a web browser, for example. The print execution unit 38 executes a print process in response to a request from the job execution unit 35. The transmission execution unit 39 executes a file transmission process or an email transmission process in response to a request from the job execution unit 35. Note that the print execution unit 38 and the transmission execution unit 39 are examples of a module that performs a workflow process.

The information storage apparatus 10 of FIG. 4 includes the SMB protocol and the web API 36 as interfaces for accessing a folder of the file server 32. Thus, even if the smart device 12 or the image processing apparatus 14 is not capable of using the SMB protocol, the smart device 12 or the image processing apparatus 14 may still access the folder of the file server 32 via the web API 36.

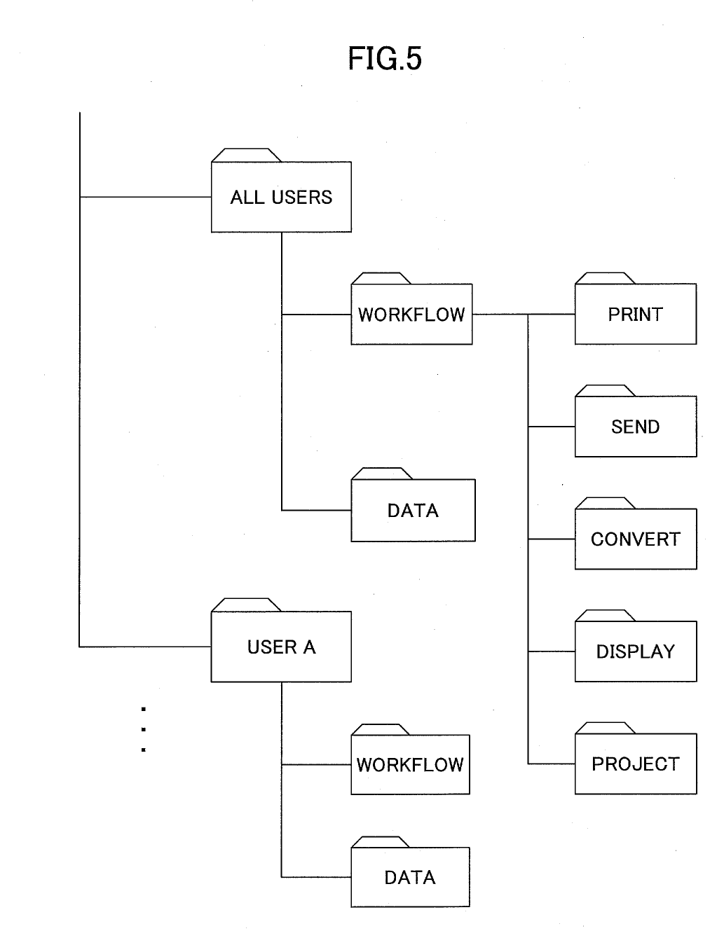

The smart device 12 and the image processing apparatus 14 are capable of storing a file in a folder of the file server 32 or acquire a file from the folder of the file server 32 using the web API 36, and in this way, the smart device 12 and the image processing apparatus 14 may be able to use a workflow folder as illustrated in FIG. 5, for example.

FIG. 5 illustrates an example folder configuration of the file server 32 according to the present embodiment. In the example of FIG. 5, the file server 32 of the information storage apparatus 10 includes an “ALL USERS” folder that is accessible by all users and a “USER” folder provided for each user.

A “WORKFLOW” folder and a “DATA” folder are provided under each of the “ALL USERS” folder and the “USER” folder. Further, workflow folders including “PRINT”, “SEND”, “CONVERT”, “DISPLAY”, and “PROJECT” workflow folders are provided under the “ALL USERS/WORKFLOW” folder. Note that in FIG. 5, the “DATA” folder represents an example of a folder other than a workflow folder.

The “PRINT”, “SEND”, “CONVERT”, “DISPLAY”, AND “PROJECT” workflow folders of FIG. 5 are examples of a folder associated with a process. For example, when the information storage apparatus 10 detects a file being saved in the “PRINT” workflow folder under the “ALL USERS/WORKFLOW” folder, the information storage apparatus 10 may execute a workflow for causing the image processing apparatus 14 to print the file. Similarly, when the information storage apparatus 10 detects a file being saved in the “PROJECT” workflow folder or the “DISPLAY” workflow folder, the information storage apparatus 10 may execute a workflow for causing the image processing apparatus 14 (e.g., a projector or a monitor) to project the file or display the file, for example. Also, when the information storage apparatus 10 detects a file being saved in the “SEND” workflow folder, the information storage apparatus 10 may execute a workflow for sending an email including the file as an attachment to a predetermined destination (e.g., destination set up in association with the “SEND” folder), for example. Alternatively, the information storage apparatus 10 may execute a workflow for causing the image processing apparatus 14 to send the file via facsimile, for example.

<Process>

In the following, processes of the information processing system 1 according to the present embodiment are described.

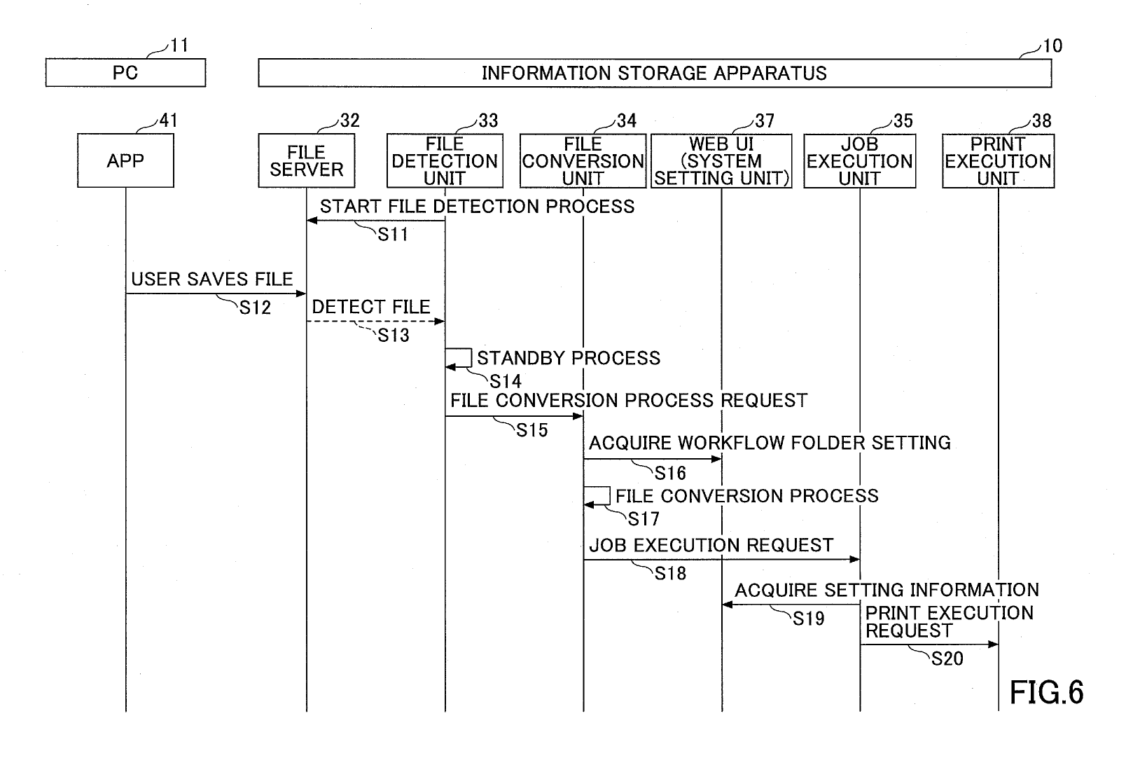

FIG. 6 is a sequence chart illustrating an example process procedure of the information processing system 1 according to the first embodiment. Note that FIG. 6 illustrates an example where the PC 11 saves a file in the “PRINT” workflow folder of the information storage apparatus 10.

In step S11, the file detection unit 33 of the information storage apparatus 10 starts a process for detecting a file being saved in a folder such as a workflow folder of the file server 32 from the time the information storage apparatus 10 is started.

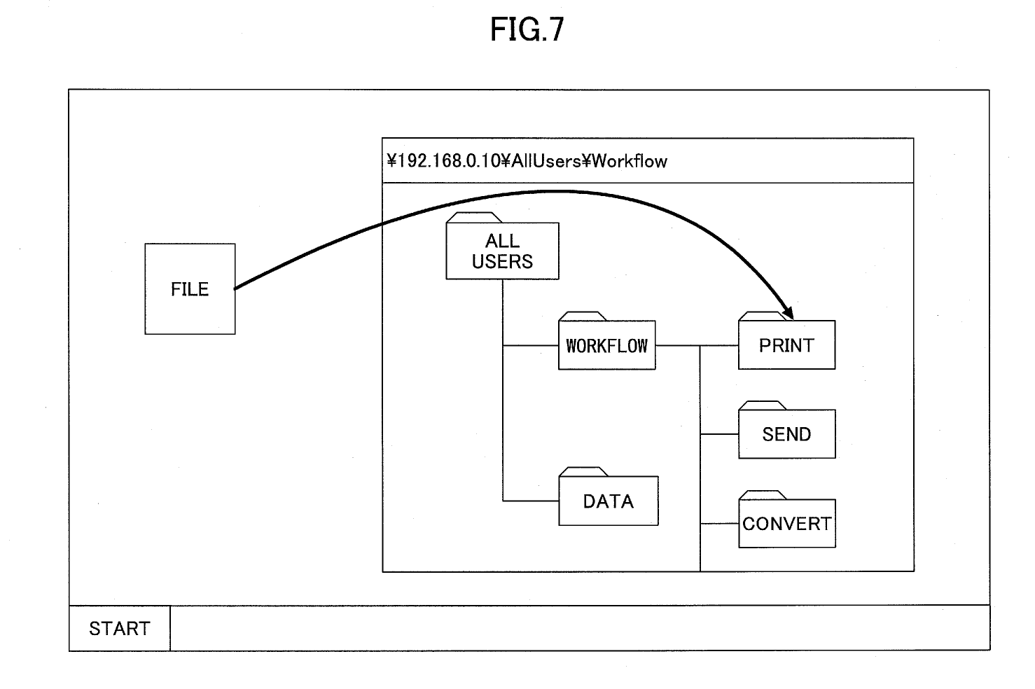

In step S12, a user of the PC 11 saves a file in the “PRINT” workflow folder of the information storage apparatus 10 by performing a drag and drop operation on the file displayed on a screen of the PC 11 as illustrated in FIG. 7, for example.

FIG. 7 illustrates an example process of the user saving a file in the “PRINT” workflow folder by a drag and drop operation. The user can save the file in any folder by dragging and dropping the file onto a desired folder. Note that in the case where the user saves a file in a folder by the drag and drop operation, the user may be prone to save the file in a wrong workflow folder, for example.

In step S13, the file detection unit 33 detects that a file has been stored in the “PRINT” workflow folder. In step S14, the file detection unit 33 performs a standby process as described below. Note that the standby process of step S14 is implemented in a case where the user saves a file in the “PRINT” workflow folder of the information storage apparatus 10 by a drag and drop operation. In the standby process of step S14, a predetermined waiting time is provided.

Such a predetermined waiting time is provided because the user is prone to make an operation error and save a file in a wrong workflow folder by the drag and drop operation. If a workflow process is started immediately after the user saves the file in a workflow folder, the user would not be able to cancel execution of the workflow process even when the user has mistakenly saved the file in the wrong workflow folder, for example. Thus, by providing the predetermined waiting time, when the user saves a file in a wrong workflow folder by mistake, the user may be able to delete the file from the workflow folder and cancel execution of the workflow process, provided the user acts within the predetermined waiting time.

After the predetermined waiting time elapses, in step S15, the file detection unit 33 requests the file conversion unit 34 to perform a file conversion process. In step S16, the file conversion unit 34 acquires settings of the “PRINT” workflow folder from the web UI 37. In step S17, the file conversion unit 34 performs a conversion process for converting the file into a file format set up in the “PRINT” workflow folder.

Then, in step S18, the file conversion unit 34 passes the file converted into the file format of the “PRINT” workflow folder to the job execution unit 35 and makes a job execution request to the job execution unit 35. In step S19, the job execution unit 35 acquires settings of the “PRINT” workflow folder from the web UI 37. In step S20, the job execution unit 35 requests the print execution unit 38 to execute a print process set up in the “PRINT” workflow folder.

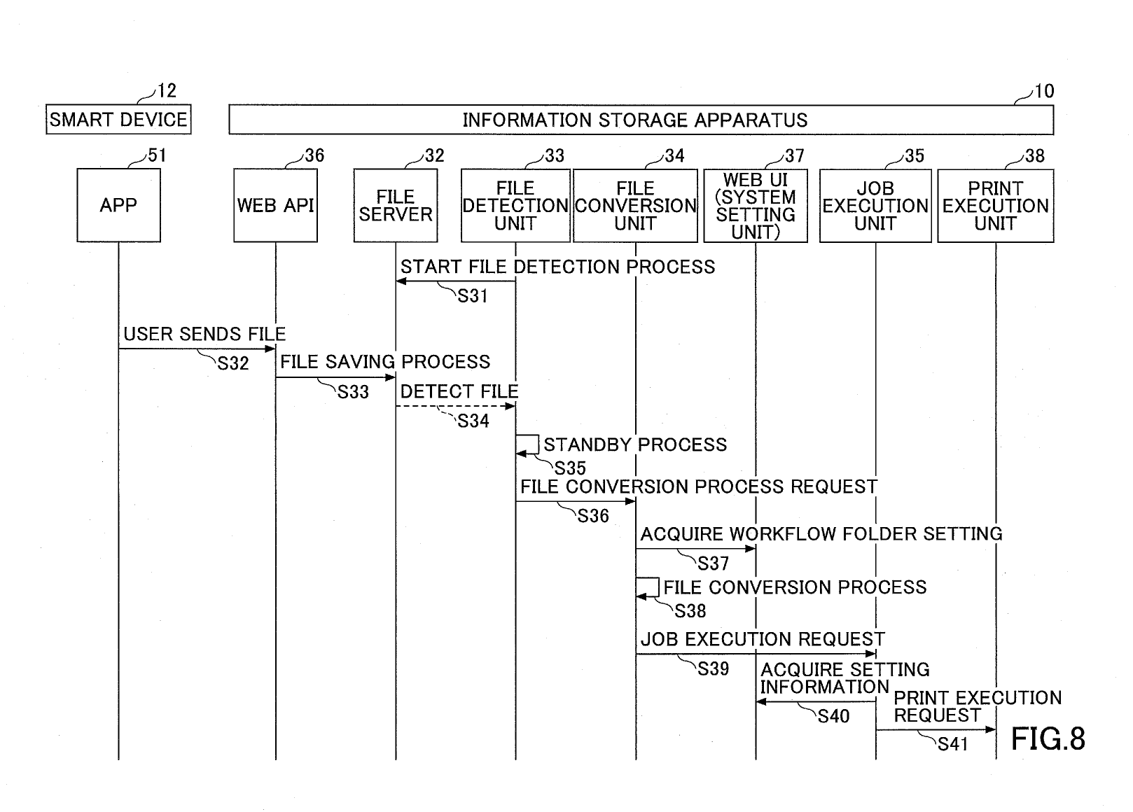

FIG. 8 is a sequence chart illustrating another example process procedure of the information processing system 1 according to the first embodiment. Note that FIG. 8 illustrates an example where the smart device 12 saves a file in the “PRINT” workflow folder of the information storage apparatus 10.

In step S31, the file detection unit 33 of the information storage apparatus 10 starts the process of detecting a file being saved in a folder such as a workflow folder of the file server 37 from the time the information storage apparatus 10 is started.

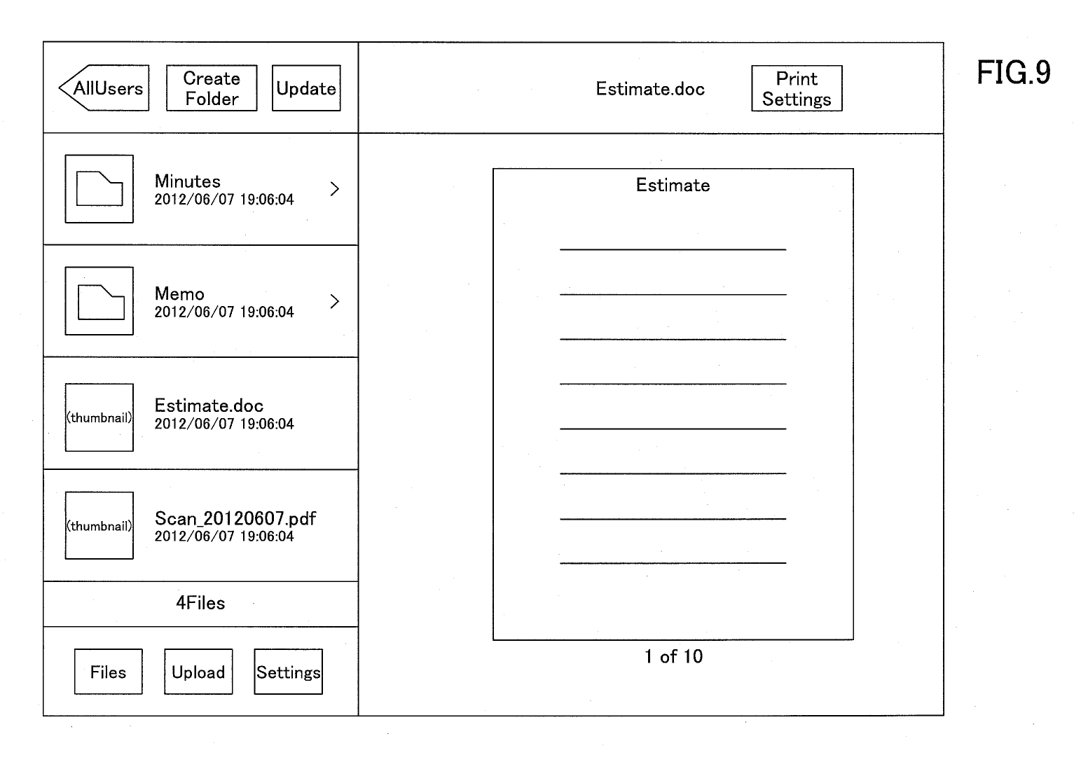

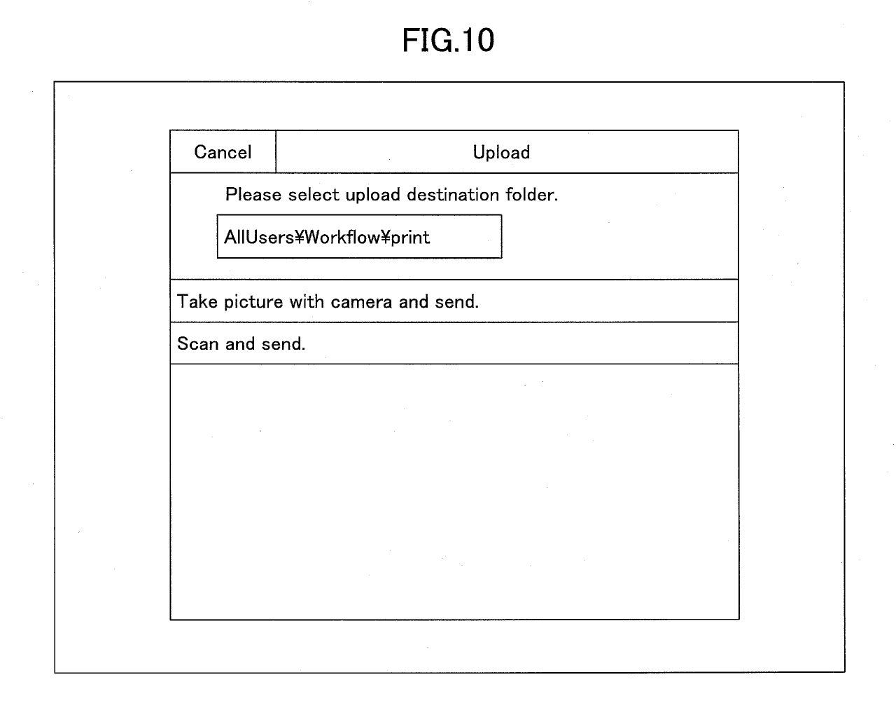

In step S32, a user of the smart device 12 makes a request to save a file in the “PRINT” workflow folder of the information storage apparatus 10 by selecting the “PRINT” workflow folder as an upload destination via display screens as illustrated in FIGS. 9 and FIG. 10, for example. The smart device 12 sends an HTTP request for saving the file in the “PRINT” workflow folder of the information storage apparatus 10 to the web API 36 of the information storage apparatus 10.

FIG. 9 illustrates an example of a file display screen displaying a file. The user can prompt the smart device 12 to display an upload destination folder selection screen as illustrated in FIG. 10 by selecting an “Upload” button displayed on the file display screen of FIG. 9. The user can then select one folder from among upload destination candidate folders via the upload destination folder selection screen of FIG. 10 and save the file in the selected folder.

Note that in the present example, the user can select one folder from among the upload destination candidate folders via the upload destination folder selection screen. In this case, the user is less likely to save the file in a wrong workflow folder by mistake as compared with the case of saving the file by the drag and drop operation as described above.

In step S33, the web API 36 receives the HTTP request from the smart device 12 and executes a process of saving the file in the “PRINT” workflow folder of the file server 32.

In step S34, the file detection unit 33 detects that a file has been stored in the “PRINT” workflow folder. In step S35, the file detection unit 33 performs a standby process as described below. Note that the standby process of step S35 is implemented in a case where the user saves a file in the “PRINT” workflow folder of the information storage apparatus 10 by an operation other than the drag and drop operation. In the standby process of step S35, a waiting time is not provided.

The waiting time is not provided in the standby process of step S35 because the user is less likely to mistakenly save the file in a wrong workflow folder by the folder selection operation as described above. That is, when a file is saved by an operation that is not prone to error, processes set up in the workflow folder are preferably started immediately after the user saves the file in the workflow folder. By not providing a waiting time in such a case, the user may be able to start the workflow process set up in the workflow folder immediately after saving a file in the workflow folder.

Thus, in the present example, the process proceeds to step S36 immediately after the file is saved in the “PRINT” workflow folder. In step S36, the file detection unit 33 requests the file conversion unit 34 to perform a file conversion process. In step S37, the file conversion unit 34 acquires settings of the “PRINT” workflow folder from the web UI 37. In step S38, the file conversion unit 34 performs a process of converting the file into a file format set up in the “PRINT” workflow folder.

Then, the process proceeds to step S39 where the file conversion unit 34 passes the file converted into the file format of the “PRINT” workflow folder to the job execution unit 35 and makes a job execution request to the job execution unit 35. In step S40, the job execution unit 35 acquires settings of the “PRINT” workflow folder from the web UI 37. In step S41, the job execution unit 35 requests the print execution unit 38 to execute a print process set up in the “PRINT” workflow folder.

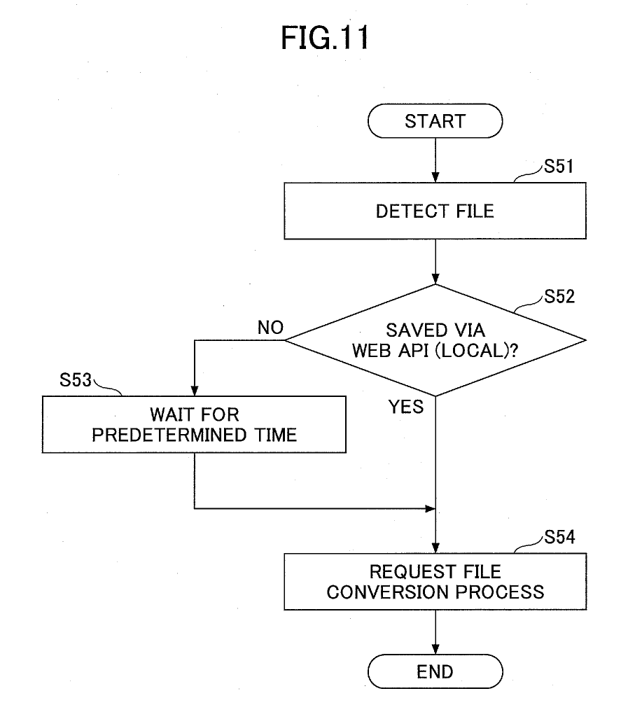

In the following, the standby process of step S14 of FIG. 6 and the standby process of step S35 of FIG. 8 are described. FIG. 11 is a flowchart illustrating an example process procedure of the standby process according to the present embodiment.

In step S51, the file detection unit 33 detects that a file has been saved in the “PRINT” workflow folder. In step S52, the file detection unit 33 determines whether the file has been saved in the “PRINT” workflow folder via the SMB protocol or via the web API 36.

For example, a file is saved via the SMB protocol in a case where the PC 11 that is connected to the information storage apparatus 10 via the network N1 directly saves the file in the “PRINT” workflow folder. On the other hand, a file is saved via the web AIP 36 in a case where an internal module of the information storage apparatus 10 saves the file in the “PRINT” workflow folder.

Accordingly, in step S52, the file detection unit 33 may determine whether the file has been saved in the “PRINT” workflow folder via the web API 36 based on the above distinctions between having the PC 11/module/user perform the process of saving the file in the “PRINT” workflow folder. If the file is not saved via the web API 36, the file detection unit 33 proceeds to step S53 where it decides to wait until a predetermined time period elapses. Then, after the predetermined time period elapses, the file detection unit 33 performs the process of step S54.

On the other hand, if the file is saved via the web API 36, the file detection unit 33 decides not to wait for the predetermined time period. That is, the file detection unit 33 skips the process of step S53 and performs the process of step S54 without waiting for the predetermined time period to elapse. In step S54, the file detection unit 33 requests the file conversion unit 34 to perform a file conversion process. Note that the process of step S54 corresponds to the process of step S15 of FIG. 6 or the process of step S36 of FIG. 8.

According to the standby process of FIG. 11, when a file is saved in the “PRINT” workflow folder of the information storage apparatus 10 by the PC 11 through a drag and drop operation, for example, the information storage apparatus 10 waits until a predetermined time period (e.g., 30 seconds) elapses before executing the process that is set up in the “PRINT” workflow folder.

Thus, when a user mistakenly saves a file in a wrong workflow folder, the user may be able to delete the file from the workflow folder and cancel the execution of the process that is set up in the workflow folder.

Also, according to the standby process of FIG. 11, when a file is saved in the “PRINT” workflow folder of the information storage apparatus 10 by the smart device 12 through an operation other than the drag and drop operation, for example, the information storage apparatus 10 does not wait for the predetermined time period (e.g., 30 seconds) to elapse.

Thus, when a user saves a file in a workflow folder using the smart device 12, for example, the user may be able to promptly obtain an execution result of the process set up in the workflow folder.

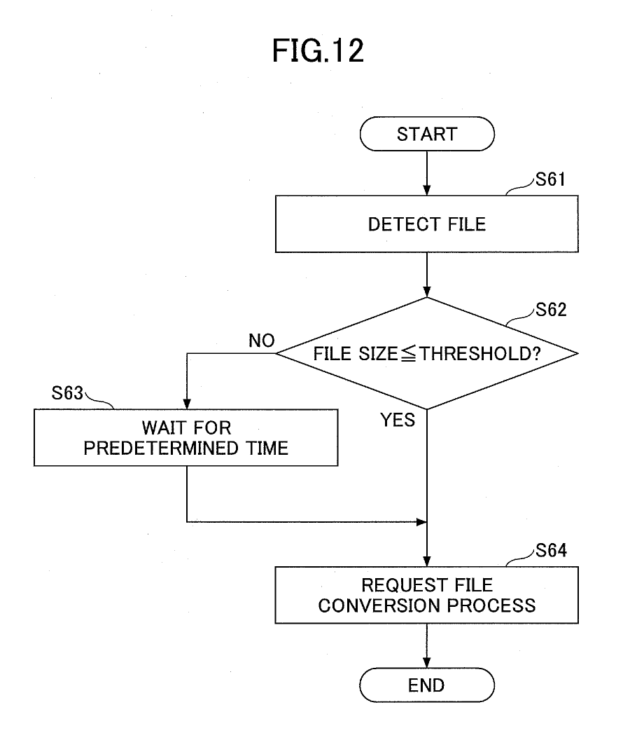

Note that the standby process of step S14 of FIG. 6 and the standby process of step S35 of FIG. 8 may also be implemented by a process procedure as illustrated in FIG. 12, for example. FIG. 12 is a flowchart illustrating another example process procedure of the standby process according to the present embodiment. Note that the process steps of FIG. 12 other than the determination process of step S62 are substantially identical to the process steps of FIG. 11, and as such, overlapping descriptions will be omitted.

In step S62, the file detection unit 33 determines whether the size of a file saved in the “PRINT” workflow folder is less than or equal to a threshold value. If the size of the saved file is greater than the threshold value, the file detection unit 33 proceeds to step S63 and decides to wait until a predetermined time period elapses. Then, after the predetermined time period elapses, the file detection unit 33 performs the process of step S64. On the other hand, if the size of the saved file is less than or equal to the threshold value, the file detection unit 33 decides not to wait for the predetermined time period. That is, the file detection unit 33 skips the process of step S63 and performs the process of step S64 without waiting until the predetermined time period elapses.

According to the standby process of FIG. 12, when the size of a file that is saved in the “PRINT” workflow folder of the information storage apparatus 10 is greater than a threshold value, the information storage apparatus 10 waits for a predetermined time period (e.g., 30 seconds) to elapse.

Thus, when a user mistakenly saves a file larger than a threshold size in a wrong workflow folder, the user may be able to delete the file from the workflow folder and cancel the execution of the process set up in the workflow folder. For example, when the user mistakenly saves a large file in the “PRINT” workflow folder, the user can prevent unnecessary printing of the file and avoid wasting resources.

Also, according to the standby process of FIG. 12, when the size of a file that is saved in the “PRINT” workflow folder of the information storage apparatus 10 is less than or equal to a threshold value, the information storage apparatus 10 does not wait for the predetermined time period (e.g., 30 seconds) to elapse.

Thus, when a user saves a file that does not exceed a threshold size in a workflow folder, the user may be able to promptly obtain an execution result of the process set up in the workflow folder.

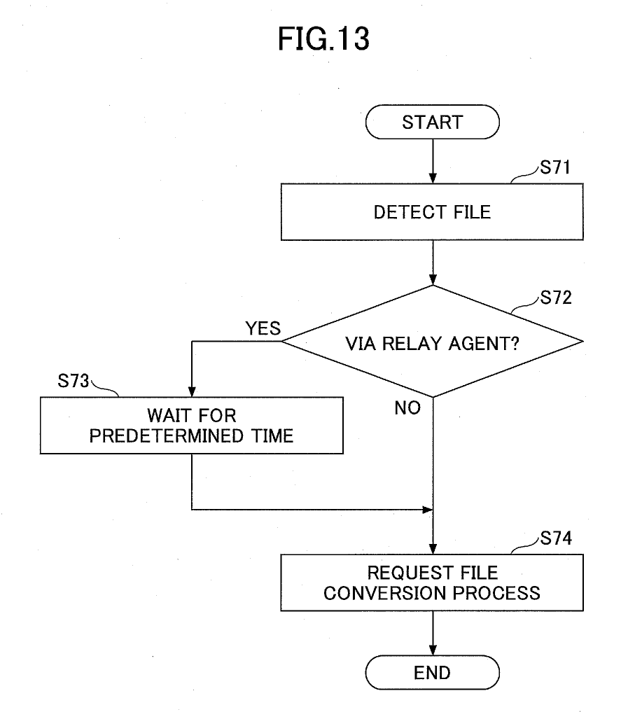

Note that the standby process of step S14 of FIG. 6 and the standby process of step S35 of FIG. 8 may also be implemented by a process procedure as illustrated in FIG. 13, for example. FIG. 13 is a flowchart illustrating another example process procedure of the standby process according to the present embodiment. Note that the process steps of FIG. 13 other than the determination process of step S72 are substantially identical to the process steps of FIG. 11, and as such, overlapping descriptions will be omitted.

Note that the standby process of FIG. 13 is implemented in a case where the smart device 12 and the image processing apparatus 14 are configured to access the information storage apparatus 10 via a relay server in the information processing system 1 of FIG. 1. Note that the relay server is used to relay requests from the smart device 12 and the image processing apparatus 14 to the information storage apparatus 10 in a system configuration where the smart device 12 and the image processing apparatus 14 are not allowed to directly access the information storage apparatus 10.

In the information processing system 1 using a relay server, the information storage apparatus 10 includes a relay agent that communicates with the relay server. In step S72 of FIG. 13, the file detection unit 33 determines whether the file detected in step S71 has been saved in the “PRINT” workflow folder via the relay agent.

If the file has been saved via the relay agent, the file detection unit 33 proceeds to step S73 where it decides to wait until a predetermined time period elapses. Then, after the predetermined time period elapses, the file detection unit 33 performs the process of step S74. On the other hand, if the file is not saved via the relay agent, the file detection unit 33 decides not to wait for the predetermined time period. That is, the file detection unit 33 skips the process of step S73 and performs the process of step S74 without waiting for the predetermined time period to elapse.

According to the standby process of FIG. 13, if a file is saved in the “PRINT” workflow folder of the information storage apparatus 10 via the relay agent, the information storage apparatus 10 waits until a predetermined time period (e.g., 30 seconds) elapses.

Thus, when a user mistakenly saves a file in a workflow folder via the relay agent, the user may be able to delete the file from the workflow folder and can cancel the execution of the process set up in the workflow folder. For example, when the user uses the smart device 12 to save a file in the “PRINT” workflow folder via the relay server, a waiting time may be provided during which the user may be able to cancel the print process set up in the “PRINT” workflow folder.

Also, according to the standby process of FIG. 13, when a file is not saved in the “PRINT” workflow folder of the information storage apparatus 10 via the relay agent, the information storage apparatus 10 does not wait for the predetermined time period (e.g., 30 seconds).

Thus, if the user has not saved the file in the workflow folder via the relay agent, the user may be able to promptly obtain an execution result of the process set up in the workflow folder.

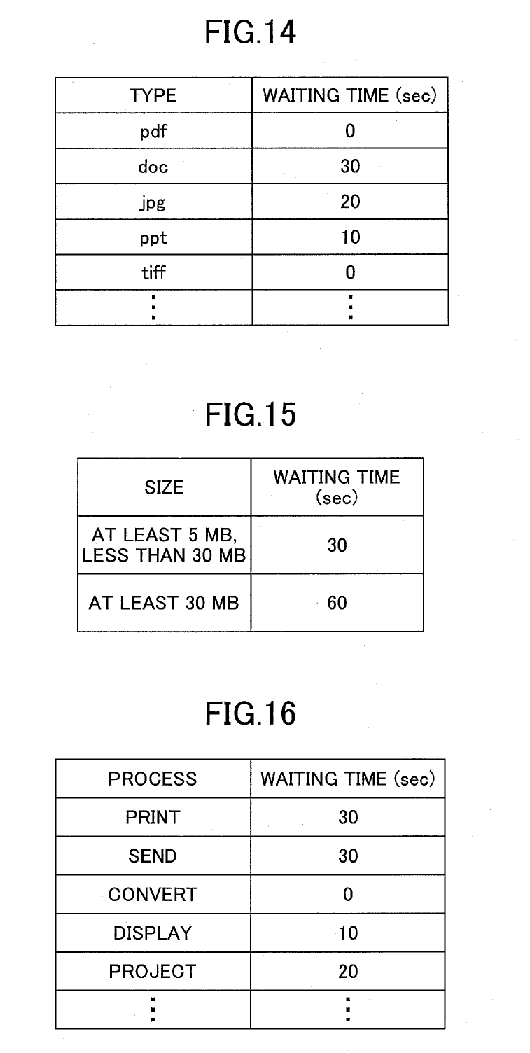

Note that in the example standby processes of steps S53, S63, and S73 of FIGS. 11 to 13 described above, a fixed time period is set up as the waiting time. However, the waiting time may be variable as illustrated in FIGS. 14 to 16, for example.

FIG. 14 is a table illustrating an example of the waiting time varying depending on the file type. FIG. 15 is a table illustrating an example of the waiting time varying depending on the file size. FIG. 16 is a table illustrating an example of the waiting time varying depending on the type of process set up in the workflow folder. In this way, the waiting time for the standby processes of FIGS. 11 to 13 can be variably determined based on the file type, the file size, or the type of process set up in the workflow folder as illustrated in FIGS. 14 to 16, for example.

As described above, in the information processing system 1 according to the first embodiment, when a file is saved in a workflow folder by the PC 11, a process set up in the workflow folder is started after a predetermined time period elapses such that the process may be canceled in a case where the file is saved in the workflow folder by mistake.

Also, in the information processing system 1 according to the first embodiment, when a file is saved in a workflow folder by the smart device 12 or the image processing apparatus 14, a process set up in the workflow folder is started without any waiting time being provided after the file is saved, and in this way, an execution result of the process can be promptly obtained.

As can be appreciated, the information processing system 1 according to the first embodiment is capable of flexibly adjusting the waiting time before starting a process associated with a workflow folder.

### Second Embodiment

In the information processing system 1 according to the first embodiment, the standby process is executed by the information storage apparatus 10, whereas the PC 11, the smart device 12, or the image processing apparatus 14 that is used to save the file is not involved in the execution of the standby process. In the information processing system according to a second embodiment of the present invention, the PC 11, the smart device 12, or the image processing apparatus 14 that is used to save the file cooperates with the information storage apparatus 10 to execute the standby process. Note that in the following, descriptions of features and elements of the second embodiment that are substantially identical to those of the first embodiment will be omitted.

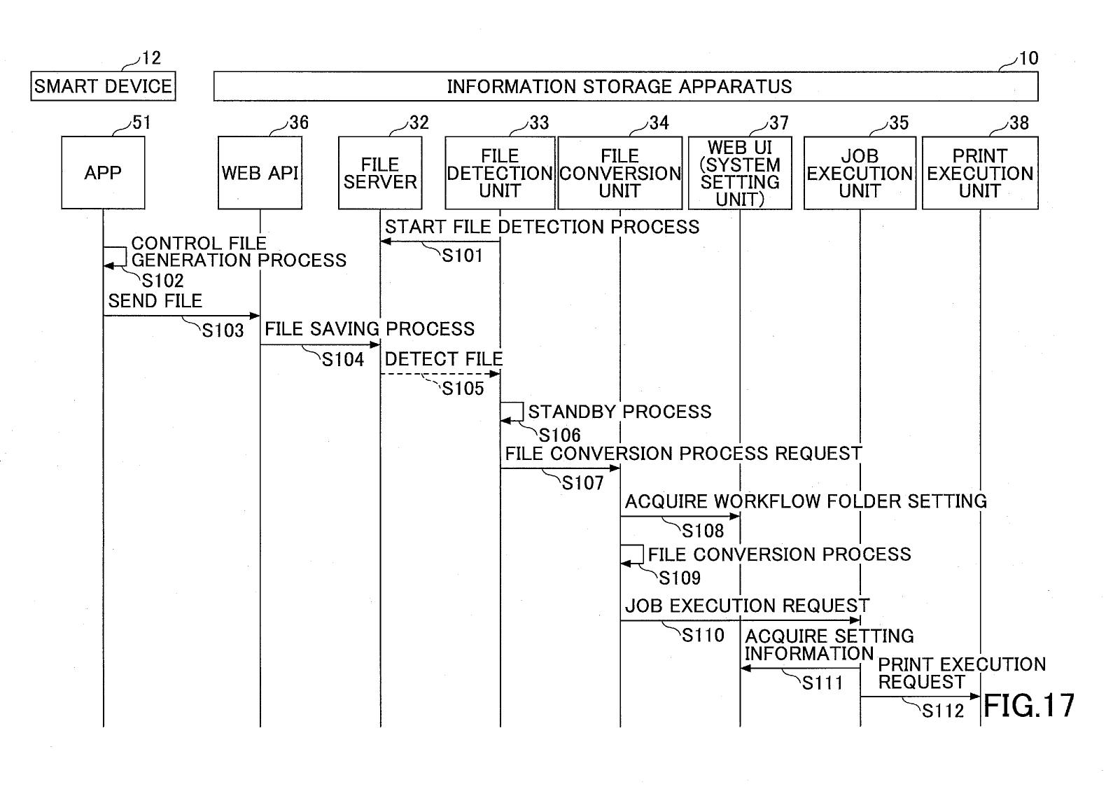

FIG. 17 is a sequence chart illustrating an example process procedure of the information processing system 1 according to the second embodiment. Note that FIG. 17 illustrates an example where a file is saved in the “PRINT” workflow folder of the information storage apparatus 10 by the smart device 12.

In step S101, the file detection unit 33 of the information storage apparatus 10 starts the process of detecting a file being saved in a folder such as a workflow folder of the file server 32 from the time the information storage apparatus 10 is started.

In step S102, the user of the smart device 12 makes a request to save a file in the “PRINT” workflow folder of the information storage apparatus 10 by selecting the “PRINT” workflow folder as an upload destination folder via display screens as illustrated in FIGS. 9 and FIG. 10, for example. In turn, the smart device 12 performs a control file generation process to generate a control file as described below. Note that in the following descriptions, the file to be used in executing the workflow process of the “PRINT” workflow folder is referred to as “workflow file”.

Then, in step S103, the smart device 12 sends an HTTP request for saving the generated control file and the workflow file in the “PRINT” workflow folder to the web AIP 36 of the information storage apparatus 10.

In step S104, the web API 36 receives the HTTP request from the smart device 12 and executes a process of saving the control file and the workflow file in the “PRINT” workflow folder of the file server 32.

In step S105, the file detection unit 33 detects the control file and the workflow file saved in the “PRINT” workflow folder. In step S106, the file detection unit 33 performs a standby process as described below. Note that the standby process of step S106 is implemented in a case where a control file is saved in the “PRINT” workflow folder. In the standby process of step S106, a waiting time is not provided. By not providing the waiting time, the user may be able to start the process set up in the “PRINT” workflow folder immediately after saving the file in the “PRINT” workflow folder.

Thus, in the present example, the process proceeds to step S107 immediately after the control file and the workflow file are saved in the “PRINT” workflow folder. In step S107, the file detection unit 33 requests the file conversion unit 34 to perform a file conversion process. Note that the processes of step S107 and the subsequent steps are substantially identical to the processes of step S36 and the subsequent steps of FIG. 8.

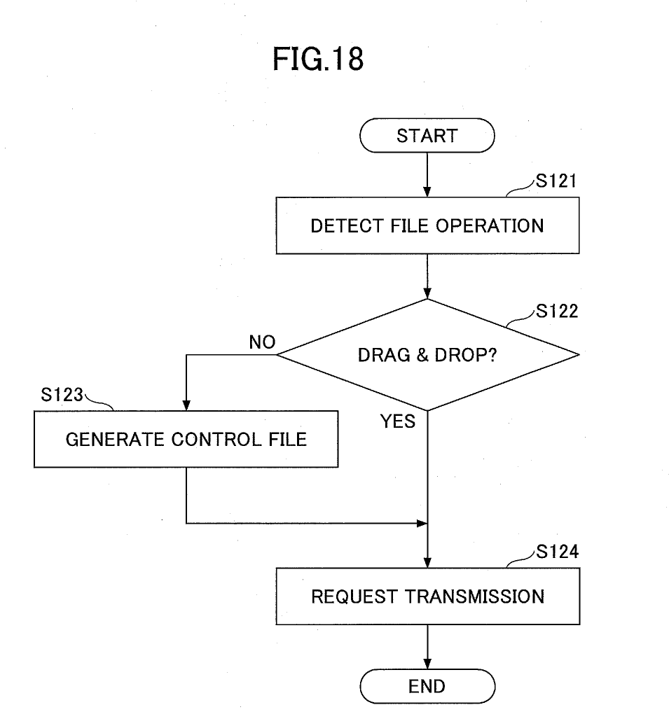

In the following, the control file generation process of step S102 of FIG. 17 is described. FIG. 18 is a flowchart illustrating an example process procedure of the control file generation process according to the present embodiment.

In step S121, the smart device 12 detects an operation performed by the user for saving a file in the “PRINT” workflow folder. In step S122, the smart device 12 determines whether the operation for saving the file accepted from the user corresponds to a drag and drop operation.

When the smart device 12 accepts a user operation other than a drag and drop operation, the smart device 12 proceeds to step S123 where it generates a control file to control the information storage apparatus 10 to refrain from providing a waiting time in the standby process. Then, the process proceeds to step S124 where the smart device 12 requests the transmission of the generated control file and the workflow file to the information storage apparatus 10.

On the other hand, when the smart device 12 accepts a drag and drop operation by the user, the smart device 12 skips the control file generation process of step S123. That is, the smart device 12 does not generate a control file for controlling the information storage apparatus 10 to refrain from providing a waiting time. Thus, the smart device 12 proceeds to step S124 where it requests for the transmission of the workflow file to the information storage apparatus 10.

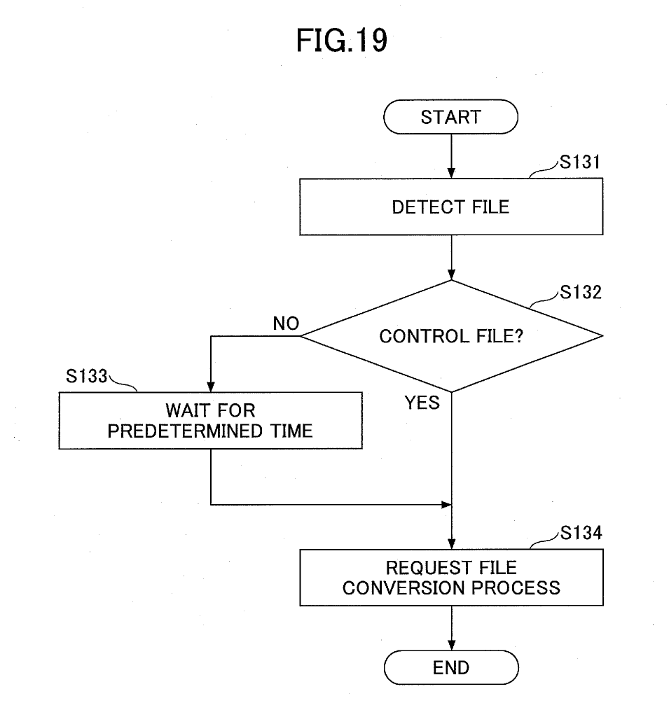

In the following, the standby process of step S106 of FIG. 17 is described. FIG. 19 is a flowchart illustrating an example process procedure of the standby process according to the present embodiment.

In step S131, the file detection unit 33 detects a file being saved in the “PRINT” workflow folder. In step S132, the file detection unit 33 determines whether a control file has been saved the “PRINT” workflow folder in step S131.

If the control file is not saved in the “PRINT” workflow folder, the file detection unit 33 proceeds to step S133 where it decides to wait until a predetermined time period elapses. Then, after the predetermined time period elapses, the file detection unit 33 performs the process of step S134. On the other hand, if the control file is saved in the “PRINT” workflow folder, the file detection unit 33 decides not to wait for the predetermined time period to elapse. That is, the file detection unit 33 skips the process of step S133 and performs the process of step S134 without waiting until the predetermined time period elapses.

In step S134, the file detection unit 33 requests the file conversion unit 34 to perform a file conversion process. Note that the process of step S134 corresponds to the process of step S107 of FIG. 17.

According to the standby process of FIG. 19, when a file is saved in the “PRINT” workflow folder of the information storage apparatus 10 by the smart device 12 through a drag and drop operation, the information storage apparatus 10 waits until a predetermined time period (e.g., 30 seconds) elapses.

Thus, when the user saves a file in a workflow folder by mistake, the user may be able to delete the file from the workflow folder and cancel the execution of the process set up in the workflow folder.

Also, according to the standby process of FIG. 19, when a file is saved in the “PRINT” workflow folder of the information storage apparatus 10 by the smart device 12 through an operation other than the drag and drop operation, the information storage apparatus 10 does not wait until the predetermined time period (e.g., 30 seconds) elapses.

Thus, when the user uses the smart device 12 to save a file in a workflow folder through an operation other than the drag and drop operation, the user may be able to promptly obtain an execution result of the process set up in the workflow folder.

Note that the control file generated in the present embodiment may be any file defined in the information processing system 1. For example, a file with a file extension “end” may be regarded as the control file.

Also, according to an aspect of the second embodiment, the information processing system 1 may be configured to not provide a waiting time in the case where the PC 11 saves a file in the “PRINT” workflow folder via the SMB protocol, for example. Also, the information processing system 1 may be configured to provide the waiting time in a case where a UI of an application installed in the smart device 12 is configured to accept an operation for saving a file by a drag and drop operation, for example.

According to another aspect of the present embodiment, the web API 36 may be configured to execute the control file generation process of step S102 and save the generated control file and the workflow file in the “PRINT” workflow folder, for example.

As described above, in the information processing system 1 according to the second embodiment, when a control file is not saved in a workflow folder, a waiting time is provided before a process set up in the workflow folder is started, and as such, the process can be cancelled if the file has been mistakenly saved in the workflow folder, for example. Also, in the information processing system 1 according to the second embodiment, when a control file is saved in a workflow folder, the waiting time is not provided and a process set up in the workflow folder is started immediately after the file is saved, and in this way, an execution result of the process may be promptly obtained.

As can be appreciated, the information processing system 1 according to the second embodiment is capable of flexibly adjusting the waiting time before starting a process associated with a workflow folder.

Although the present invention has been described above with reference to certain illustrative embodiments, the present invention is not limited to these embodiments, and numerous variations and modifications may be made without departing from the scope of the present invention.

What is claimed is:

1. An information storage apparatus comprising:
a storage unit including a storage area that is accessible via a network, the storage unit being configured to set up a process to be executed using electronic data stored in the storage area in association with the storage area;
a memory storing a program; and
a processor that executes the program to implement processes of
detecting the electronic data being stored in the storage area; and
executing the process set up in association with the storage area storing the electronic data using the electronic data stored in the storage area;
wherein the processor determines a waiting time from detecting the electronic data being saved in the storage area to requesting the execution of the process set up in association with the storage area storing the electronic data, the waiting time being determined based on a type of an operation performed for storing the electronic data in the storage area via the network.

2. The information storage apparatus according to claim 1, wherein
the processor determines the waiting time from detecting the electronic data being saved in the storage area to requesting the execution of the process set up in association with the storage area storing the electronic data based on whether control data is stored in the storage area.

3. The information storage apparatus according to claim 1, wherein
the processor determines the waiting time from detecting the electronic data being saved in the storage area to requesting the execution of the process set up in association with the storage area storing the electronic data based on a size of the electronic data stored in the storage area.

4. The information storage apparatus according to claim 1, wherein
the processor determines the waiting time from detecting the electronic data being saved in the storage area to requesting the execution of the process set up in association with the storage area storing the electronic data based on a data type of the electronic data stored in the storage area.

5. The information storage apparatus according to claim 1, wherein
the processor determines the waiting time from detecting the electronic data being saved in the storage area to requesting the execution of the process set up in association with the storage area storing the electronic data based on a process type of the process set up in association with the storage area storing the electronic data.

6. The information storage apparatus according to claim 1, wherein
the process set up in association with the storage area storing the electronic data is an output process for causing an output apparatus to output the electronic data.

7. The information storage apparatus according to claim 1, wherein
the process set up in association with the storage area storing the electronic data is a transmission process for attaching the electronic data to an email and transmitting the email to a predetermined destination.

8. An information storage method that is implemented by an information storage apparatus including a storage area that is accessible via a network, the information storage method comprising steps of:
setting up a process to be executed using electronic data stored in the storage area in association with the storage area;
detecting the electronic data being stored in the storage area;
determining a waiting time from detecting the electronic data being saved in the storage area to requesting execution of the process set up in association with the storage area storing the electronic data, the waiting time being determined based on a type of an operation performed for storing the electronic data in the storage area via the network; and
executing the process set up in association with the storage area storing the electronic data using the electronic data stored in the storage area in response to the request for the execution of the process.

9. An information processing system comprising:
a terminal apparatus; and
an information storage apparatus configured to store electronic data transmitted from the terminal apparatus;
wherein the information storage apparatus includes
a storage unit including a storage area that is accessible via a network, the storage unit being configured to set up a process to be executed using the electronic data stored in the storage area in association with the storage area;
a memory storing a program; and
a processor that executes the program to implement processes of
detecting the electronic data being stored in the storage area; and
executing the process set up in association with the storage area storing the electronic data using the electronic data stored in the storage area;
wherein the processor determines a waiting time from detecting the electronic data being saved in the storage area to requesting the execution of the process set up in association with the storage area storing the electronic data, the waiting time being determined based on a type of an operation performed for storing the electronic data in the storage area via the network.
